(19) United States
(12) Patent Application Publication
(10) Pub. No.: US 2009/0172348 A1
(43) Pub. Date: Jul. 2, 2009

(54) METHODS, APPARATUS, AND INSTRUCTIONS FOR PROCESSING VECTOR DATA

(76) Inventor: Robert Cavin, San Fancisco, CA (US)

Correspondence Address: INTEL CORPORATION;c/o CPA Global, P.O. BOX 52050, MINNEAPOLIS, MN, 55402, US

(21) Appl. No.: 11/964,604

(22) Filed: Dec. 26, 2007

(51) Int. Cl. G06F 15/76; G06F 9/30

(52) U.S. Cl. 712/4; 712/2; 712/208; 712/E09.023; 712/E09.028

(57) ABSTRACT

A computer processor includes control logic for executing LoadUnpack and PackStore instructions. In one embodiment, the processor includes a vector register and a mask register. In response to a PackStore instruction with an argument specifying a memory location, a circuit in the processor copies unmasked vector elements from the vector register to consecutive memory locations, starting at the specified memory location, without copying masked vector elements. In response to a LoadUnpack instruction, the circuit copies data items from consecutive memory locations, starting at an identified memory location, into unmasked vector elements of the vector register, without copying data to masked vector elements. Other embodiments are described and claimed.

### FIELD OF THE INVENTION

The present disclosure relates generally to the field of data processing, and more particularly to methods and related apparatus for processing vector data.

### BACKGROUND

A data processing system may include hardware resources, such as a central processing unit (CPU), random access memory (RAM), read-only memory (ROM), etc. The processing system may also include software resources, such as a basic input/output system (BIOS), a virtual machine monitor (VMM), and one or more operating systems (OSs).

The CPU may provide hardware support for processing vectors. A vector is a data structure that holds a number of consecutive data items. A vector register of size M may contain N vector elements of size O, where N=M/O. For instance, a 64-byte vector register may be partitioned into (a) 64 vector elements, with each element holding a data item that occupies 1 byte, (b) 32 vector elements to hold data items that occupy 2 bytes (or one “word”) each, (c) 16 vector elements to hold data items that occupy 4 bytes (or one “doubleword”) each, or (d) 8 vector elements to hold data items that occupy 8 bytes (or one “quadword”) each.

To provide for data level parallelism, the CPU may support single instruction, multiple data (SIMD) operations. SIMD operations involve application of the same operation to multiple data items. For instance, in response to a single SIMD add instruction, a CPU may add each element in one vector to the corresponding element in another vector. The CPU may include multiple processing cores to facilitate parallel operations.

### BRIEF DESCRIPTION OF THE DRAWINGS

Features and advantages of the present invention will become apparent from the appended claims, the following detailed description of one or more example embodiments, and the corresponding figures, in which:

FIG. 1 is a block diagram depicting a suitable data processing environment in which certain aspects of an example embodiment of the present invention may be implemented;

FIG. 2 is a flowchart of an example embodiment of a process for processing vectors in the processing system of FIG. 1; and

FIGS. 3 and 4 are block diagrams depicting example storage constructs used in the embodiment of FIG. 1 for processing vectors.

### DETAILED DESCRIPTION

A program in a processing system may create a vector that contains thousands of elements. Also, the processor in the processing system may include a vector register that can only hold 16 elements at once. Consequently, the program may process the thousands of elements in the vector in batches of 16. The processor may also include multiple processing units or processing cores (e.g., 16 cores), for processing multiple vector elements in parallel. For instance, the 16 cores may be able to process the 16 vector elements in parallel, in 16 separate threads or streams of execution.

However, in some applications, most of the elements of a vector will typically need little or no processing. For instance, a ray tracing program may use vector elements to represent rays, and that program may test over 10,000 rays and determine that only 99 of them bounce off of a given object. If a ray intersects the given object, the ray tracing program may need to perform addition processing for that ray element, to effectuate the ray interacting with the object. However, for most of the rays, which do not intersect the object, no addition processing is needed. For example, a branch of the program may perform the following operations:

```
If (ray_intersects_object)
  {process bounce}
else
  {do nothing}.
```

The ray tracing program may use a conditional statement (e.g., vector compare or “vcmp”) to determine which of the elements in the vector need processing, and a bit mask or “writemask” to record the results. The bit map may thus “mask” the elements that do not need processing.

When a vector contains many elements, it is sometimes the case that few of the vector elements remain unmasked after one or more conditional checks in the application. If there is significant processing to be done in this branch and the elements that meet the condition are sparsely arranged, a sizable percentage of the vector processing capability can be wasted. For example, a program branch involving a simple if/then type statement using vcmp and writemasks can result in a few or even no unmasked elements being processed until exiting this branch in control flow.

Since a large amount of time might be needed to process a vector element (e.g., to process a ray hitting an object), efficiency can be improved by packing the 99 interesting rays (out of the 10,000 s) into a contiguous chunk of vector elements, so that the 99 elements can be processed 16 at a time. Without such bundling, the data parallel processing could be very inefficient when the problem set is sparse (i.e., when the interesting work is associated with memory locations that are far apart, rather than bundled closely together). For instance, if the 99 interesting rays are not packed into contiguous elements, each 16-element batch may have few or no elements to process for that batch. Consequently, most of the cores may remain idle while that batch is being processed.

In addition to being useful for ray tracing applications, the technique of bundling interesting vector elements together for parallel processing provides benefits for other applications, as well, particularly for an application having one or more a large input data sets with sparse processing needs.

This disclosure describes a type of machine instruction or processor instruction that bundles all unmasked elements of a vector register and stores this new vector (a subset of the register file source) to memory beginning at an arbitrary element-aligned address. For purposes of this disclosure, this type of instruction is referred to as a PackStore instruction.

This disclosure also describes another type of processor instruction that performs more or less the reverse of the PackStore instruction. This other type of instruction loads elements from an arbitrary memory address and “unpacks” the data into the unmasked elements of the destination vector register. For purposes of this disclosure, this second type of instruction is referred to as a LoadUnpack instruction.

The PackStore instruction allows programmers to create programs that rapidly sort data from a vector into groups of data items that will each take a common control path through a branchy code sequence, for example. The programs may also use LoadUnpack to rapidly expand the data items back from a group into the original locations for those items in the data structure (e.g., into the original elements in the vector register) after the control branch is complete. Thus, these instructions provide queuing and unqueuing capabilities that may result in programs that spend less of their execution time in a state with many of the vector elements masked, compared to programs which only use conventional vector instructions.

The following pseudo code illustrates an example method for processing a sparse data set:

```
If (v1 == v2)
  { VCMP k1, v1, v2 {eq}
  --Now mask k1 = [1 0 0 0 1 0 0 0 0 0 0 0 0 0 0 1]--
  --So, do significant processing on only 3 elements, but using 16 cores--
  }
```

In this example, only 3 of the elements, and therefore approximately 3 of the cores, will actually be doing significant work (since only 3 bits of the mask are 1).

By contrast, the following pseudo code does the compare across a wide set of vector registers and then packs all the data associated with the valid masks (mask=1) into contiguous chunks of memory.

```
For (int i = 0; i < num_vector_elements; i++)
  { If (v1[i] == v2[i])
      { VCMP k1, v1, v2 {eq}
      -- now mask k1 = [1 0 0 0 1 0 0 0 0 0 0 0 0 0 0 1] --
      -- So, store V3[i] to [rax] --
      PackStore [rax], v3[i]{k1}
      }
      Rax += num_masks_set
  }
For (int i = 0; i < num_masks_set; i++)
  { -- Do significant processing on 16 elements at once, using 16 cores --
  }
Unpack
```

Although there is overhead from the packing and unpacking, when the elements which require work are sparse and the work is significant, this second approach is typically more efficient.

In addition, in at least one embodiment, PackStore and LoadUnpack can also perform on-the-fly format conversions for data being loaded into a vector register from memory and for data being stored into memory from a vector register. The supported format conversions may include conversions one way or each way between numerous different format pairs, such as 8 bits and 32 bits (e.g., uint8->float32, uint8->uint32), 16 bits and 32 bits (e.g., sint16->float32, sint16->int32), etc. In one embodiment, operation codes (opcodes) may use a format like the following to indicate the desired format conversion:
LoadUnpackMN: specifies that each data item occupies M bytes in memory, and will be converted to N bytes for loading into a vector element that occupies N bytes.
PackLoadOP: specifies that each vector element the occupies 0 bytes in the vector register, and will be converted to P bytes to be stored in memory Other types of conversion indicators (e.g., instruction parameters) may be used to specify the desired format conversion in other embodiments.

In addition to being useful for queuing and unqueuing, these instructions may also prove more convenient and efficient than vector instructions which require memory to be aligned with the entire vector. By contrast, PackStore and LoadUnpack may be used with memory locations that are only aligned to the size of an element of the vector. For instance, a program may execute a LoadUnpack instruction with 8-bit-to-32-bit conversion, in which case the load can be from any arbitrary memory pointer. Additional details pertaining to example implementations of PackStore and LoadUnpack instructions are provided below.

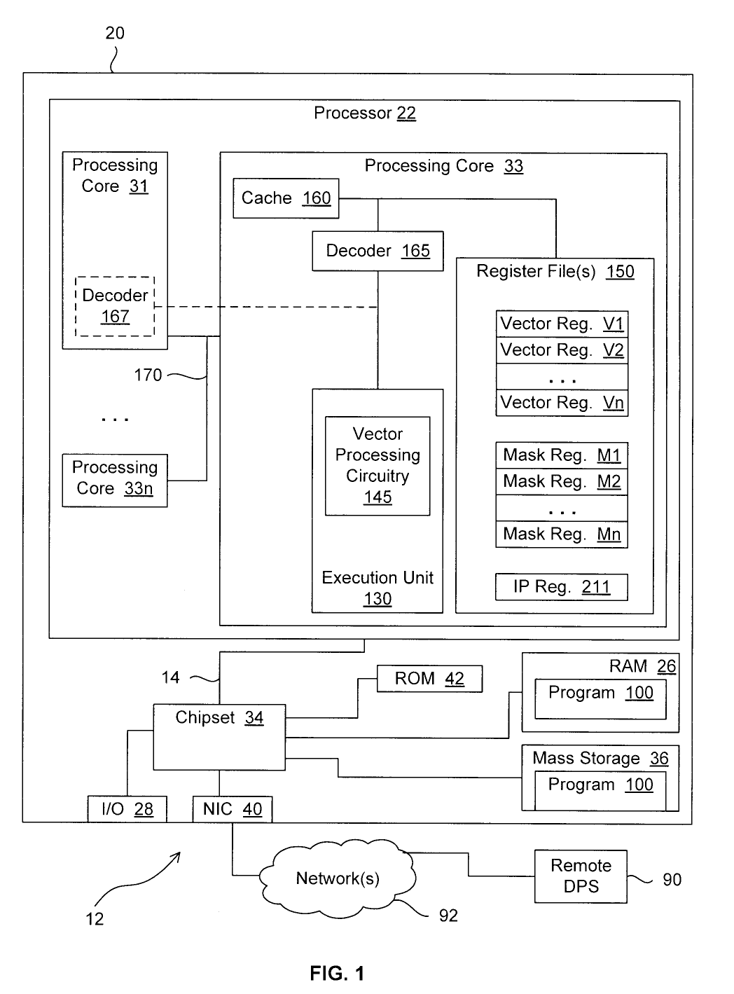

FIG. 1 is a block diagram depicting a suitable data processing environment 12 in which certain aspects of an example embodiment of the present invention may be implemented. Data processing environment 12 includes a processing system 20 that has various hardware components 82, such as one or more CPUs or processors 22, along with various other components, which may be communicatively coupled via one or more system buses 14 or other communication pathways or mediums. This disclosure uses the term “bus” to refer to shared (e.g., multi-drop) communication pathways, as well as point-to-point pathways. Each processor may include one or more processing units or cores. The cores may be implemented as Hyper-Threading (HT) technology, or as any other suitable technology for executing multiple threads or instructions simultaneously or substantially simultaneously.

Processor 22 may be communicatively coupled to one or more volatile or non-volatile data storage devices, such as RAM 26, ROM 42, mass storage devices 36 such as hard drives, and/or other devices or media, such as floppy disks, optical storage, tapes, flash memory, memory sticks, digital versatile disks (DVDs), etc. For purposes of this disclosure, the terms “read-only memory” and “ROM” may be used in general to refer to non-volatile memory devices such as erasable programmable ROM (EPROM), electrically erasable programmable ROM (EEPROM), flash ROM, flash memory, etc. Processing system 20 uses RAM 26 as main memory. In addition, processor 22 may include cache memory that can also serve temporarily as main memory.

Processor 22 may also be communicatively coupled to additional components, such as a video controller, integrated drive electronics (IDE) controllers, small computer system interface (SCSI) controllers, universal serial bus (USB) controllers, input/output (I/O) ports 28, input devices, output devices such as a display, etc. A chipset 34 in processing system 20 may serve to interconnect various hardware components. Chipset 34 may include one or more bridges and/or hubs, as well as other logic and storage components.

Processing system 20 may be controlled, at least in part, by input from input devices such as a keyboard, a mouse, etc., and/or by directives received from another machine, biometric feedback, or other input sources or signals. Processing system 20 may utilize one or more connections to one or more remote data processing systems 90, such as through a network interface controller (NIC) 40, a modem, or other communication ports or couplings. Processing systems may be interconnected by way of a physical and/or logical network 92, such as a local area network (LAN), a wide area network (WAN), an intranet, the Internet, etc. Communications involving network 92 may utilize various wired and/or wireless short range or long range carriers and protocols, including radio frequency (RF), satellite, microwave, Institute of Electrical and Electronics Engineers (IEEE) 802.11, 802.16, 802.20, Bluetooth, optical, infrared, cable, laser, etc. Protocols for 802.11 may also be referred to as wireless fidelity (WiFi) protocols. Protocols for 802.16 may also be referred to as WiMAX or wireless metropolitan area network protocols, and information concerning those protocols is currently available at grouper.ieee.org/groups/802/16/published.html.

Some components may be implemented as adapter cards with interfaces (e.g., a peripheral component interconnect (PCI) connector) for communicating with a bus. In some embodiments, one or more devices may be implemented as embedded controllers, using components such as programmable or non-programmable logic devices or arrays, application-specific integrated circuits (ASICs), embedded processors, smart cards, and the like.

The invention may be described herein with reference to data such as instructions, functions, procedures, data structures, application programs, configuration settings, etc. When the data is accessed by a machine, the machine may respond by performing tasks, defining abstract data types, establishing low-level hardware contexts, and/or performing other operations, as described in greater detail below. The data may be stored in volatile and/or non-volatile data storage. For purposes of this disclosure, the term “program” covers a broad range of software components and constructs, including applications, drivers, processes, routines, methods, modules, and subprograms. The term “program” can be used to refer to a complete compilation unit (i.e., a set of instructions that can be compiled independently), a collection of compilation units, or a portion of a compilation unit. Thus, the term “program” may be used to refer to any collection of instructions which, when executed by a processing system, perform a desired operation or operations.

In the embodiment of FIG. 1, at least one program 100 is stored in mass storage device 36, and processing system 20 can copy program 100 into RAM 26 and execute program 100 on processor 22. Program 100 includes one or more vector instructions, such as LoadUnpack instructions and PackStore instructions. Program 100 and/or alternative programs can be written to cause processor 22 to use LoadUnpack instructions and PackStore instructions for graphics operations such as ray tracing, and/or for numerous other purposes, such as text processing, rasterization, physics simulations, etc.

In the embodiment of FIG. 1, processor 22 is implemented as a single chip package that includes multiple cores (e.g., processing core 31, processing core 33, processing core 33n). Processing core 31 may serve as a main processor, and processing core 33 may serve as an auxiliary core or coprocessor. Processing core 33 may serve, for example, as a graphics coprocessor, a graphics processing unit (GPU), or a vector processing unit (VPU) capable of executing SIMD instructions.

Additional processing cores in processing system 20 (e.g., processing core 33n) may also serve as coprocessors and/or as a main processor. For instance, in one embodiment, a processing system may have a CPU with one main processing core and sixteen auxiliary processing cores. Some or all of the cores may be able to execute instructions in parallel with each other. In addition, each individual core may be able to execute two or more instructions simultaneously. For instance, each core may operate as a 16-wide vector machine, processing up to 16 elements in parallel. For vectors with more than 16 elements, the software can split the vector into subsets that each contain 16 elements (or a multiple thereof), with two or more subsets to execute substantially simultaneously on two or more cores. Also, one or more of the cores may be superscalar (e.g., capable of performing parallel/SIMD operations and scalar operations). Furthermore, any suitable variations on the above configurations may be used in other embodiments, such as CPUs with more or fewer auxiliary cores, etc.

In the embodiment of FIG. 1, processing core 33 includes an execution unit 130 and one or more register files 150. Register files 150 may include various vector registers (e.g., vector register V1, vector register V2, . . . , vector register Vn) and various mask registers (e.g., mask register M1, mask register M2, . . . , mask register Mn). Register files may also include various other registers, such as one or more instruction pointer (IP) registers 211 for keeping track of the current or next processor instruction(s) for execution in one or more execution streams or threads, and other types of registers.

Processing core 33 also includes a decoder 165 to recognize and decode instructions of an instruction set that includes PackStore and LoadUnpack instructions, for execution by execution unit 130. Processing core 33 may also include a cache memory 160. Processing core 31 may also include components like a decoder, an execution unit, a cache memory, register files, etc. Processing cores 31, 33, and 33n and processor 22 also include additional circuitry which is not necessary to the understanding of the present invention.

In the embodiment, of FIG. 1, decoder 165 is for decoding instructions received by processing core 33, and execution unit 130 is for executing instructions received by processing core 33. For instance, decoder 165 may decode machine instructions received by processor 22 into control signals and/or microcode entry points. These control signals and/or microcode entry points may be forwarded from decoder 165 to execution unit 130.

In an alternative embodiment, as depicted by the dashed lines in FIG. 1, a decoder 167 in processing core 31 may decode the machine instructions received by processor 22, and processing core 31 may recognize some instructions (e.g., PackStore and LoadUnpack) as being of a type that should be executed by a coprocessor, such as core 33. The instructions to be routed from decoder 167 to another core may be referred to as coprocessor instructions. Upon recognizing a coprocessor instruction, processing core 31 may route that instruction to processing core 33 for execution. Alternatively, the main core may send certain control signals to the auxiliary core, wherein those control signals correspond to the coprocessor instructions to be executed.

In an alternative embodiment, different processing cores may reside on separate chip packages. In other embodiments, more than two different processors and/or processing cores may be used. In another embodiment, a processing system may include a single processor with a single processing core with facilities for performing the operations described herein. In any case, at least one processing core is capable of executing at least one instruction that bundles unmasked elements of a vector register and stores the bundled elements to memory beginning at a specified address, and/or at least one instruction that loads elements from a specified memory address and unpacks the data into the unmasked elements of a destination vector register. For example, in response to receiving a PackStore instruction, decoder 165 may cause vector processing circuitry 145 within execution unit 130 to perform the required packing and storing. And in response to receiving a LoadUnpack instruction, decoder 165 may cause vector processing circuitry 145 within execution unit 130 to perform the required loading and unpacking.

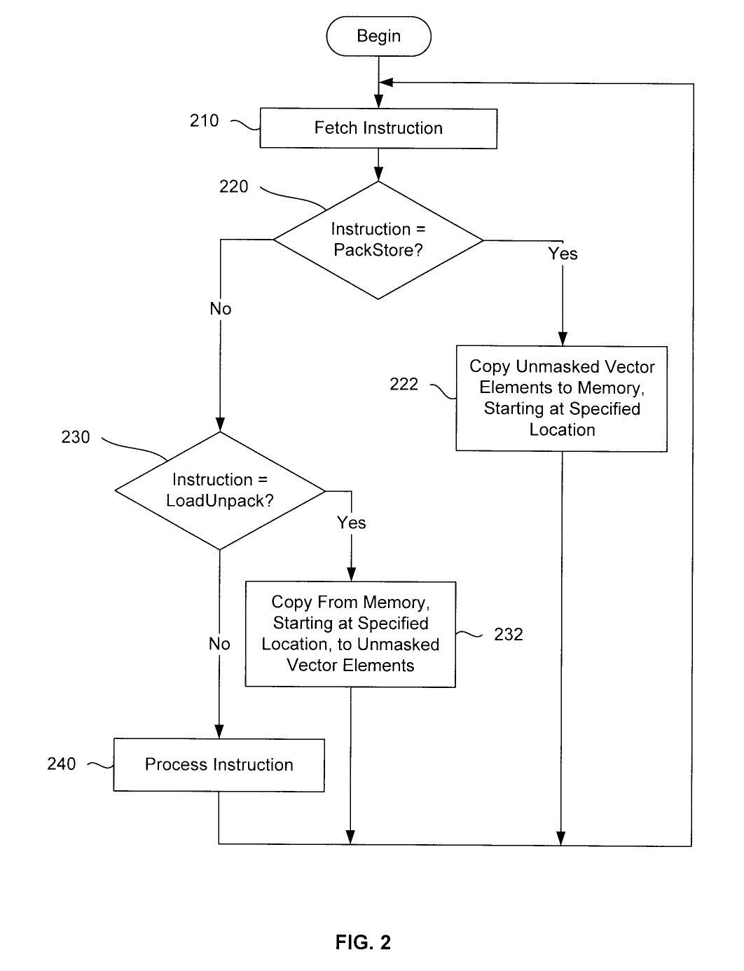

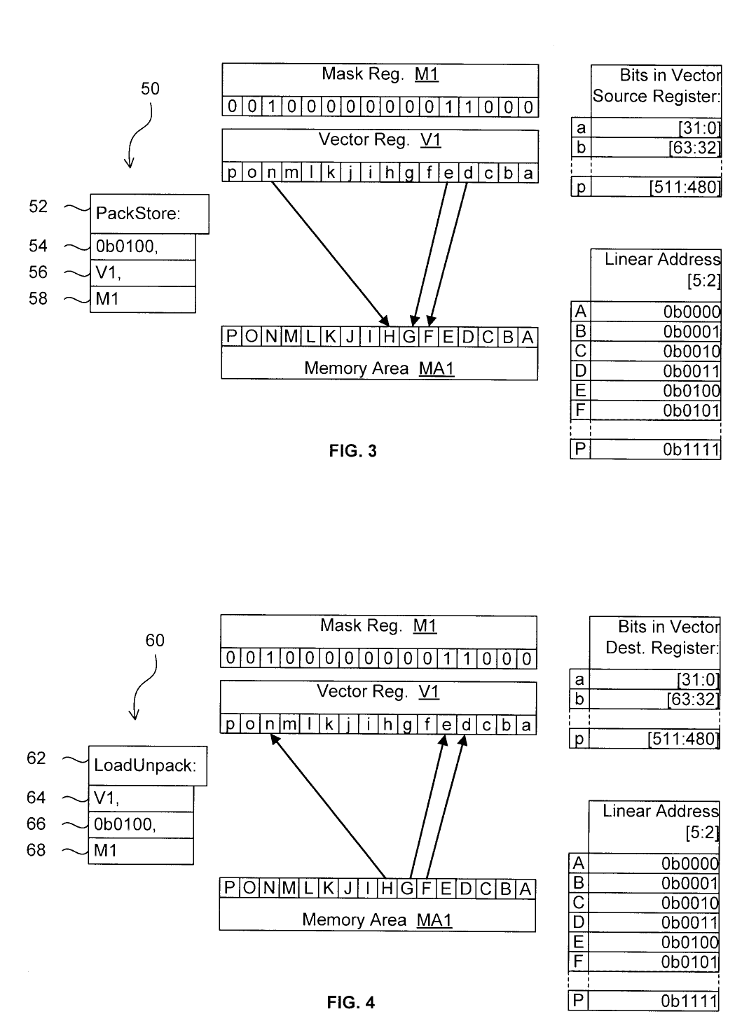

FIG. 2 is a flowchart of an example embodiment of a process for processing vectors in the processing system of FIG. 1. The process begins at block 210 with decoder 165 receiving a processor instruction from a program 100. Program 100 may be a program for rendering graphics, for instance. At block 220, decoder 165 determines whether the instruction is a PackStore instruction. If the instruction is a PackStore instruction, decoder 165 dispatches the instruction, or signals corresponding to the instruction, to execution unit 130. As shown at block 222, in response to receiving that input, vector processing circuitry 145 in execution unit 130 may copy the unmasked vector elements from the specified vector register to memory, starting at a specified memory location. Vector processing circuitry 145 may also be referred to as a vector processing unit 145. Specifically, vector processing unit 145 may pack the data from the unmasked elements into one contiguous storage space in memory, as explained in greater detail below with regard to FIG. 3.

However, if the instruction is not a PackStore instructions, the process may pass from block 220 to block 230, which depicts decoder 165 determining whether the instruction is a LoadUnpack instruction. If the instruction is a LoadUnpack instruction, decoder 165 dispatches the instruction, or signals corresponding to the instruction, to execution unit 130. As shown at block 232, in response to receiving that input, vector processing circuitry 145 in execution unit 130 may copy data from contiguous locations in memory, starting at a specified location, into unmasked vector elements of a specified vector register, where data in a specified mask register indicates which vector elements are masked. As shown at block 240, if the instruction is not a PackStore and not a LoadUnpack, processor 22 may then use more or less conventional techniques to execute the instruction.

FIG. 3 is a block diagram depicting example arguments and storage constructs for executing a PackStore instruction. In particular, FIG. 3 shows an example template 50 for a PackStore instruction. For instance, PackStore template 50 indicates that the PackStore instruction may include an opcode 52, and a number of arguments or parameters, such as a destination parameter 54, a source parameter 56, and a mask parameter 58. In the example of FIG. 3, opcode 52 identifies the instruction as a PackStore instruction, destination parameter 54 specifies a memory location to be used as a destination for the result, source parameter 56 specifies a source vector register, and mask parameter 58 specifies a mask register with bits that correspond to elements in the specified vector register.

In particular, FIG. 3 illustrates that the specific PackStore instruction in template 50 associates mask register M1 with vector register V1. In addition, the upper-right table in FIG. 3 shows how different sets of bits in vector register V1 correspond to different vector elements. For instance, bits 31:0 contain element a, bits 63:32 contain element b, etc. Furthermore, mask register M1 is shown aligned with vector register V1 to illustrate that bits in mask register M1 correspond to elements in vector register V1. For instance, the first three bits (from the right) in mask register M1 contains 0 s, thereby indicating that elements a, b, and c are masked. All of the other elements are also masked, except for elements d, e, and n, which correspond to 1 s in mask register M1. Also, the lower-right table in FIG. 3 shows the different addresses associated with different locations within memory area MA1. For instance, linear address 0b0100 (where the prefix 0b denotes binary notation) references element E in memory area MA1, linear address 0b0101 references element F in memory area MA1, etc.

As indicated above, processor 22 may receive a processor instruction having a source parameter to specify a vector register, a mask parameter to specify a mask register, and destination parameter to specify a memory location. In response to receiving the processor instruction, processor 22 may copy vector elements which correspond to unmasked bits in the specified mask register to consecutive memory locations, starting at the specified memory location, without copying vector elements which correspond to masked bits in the specified mask register.

Thus, as illustrated by the arrows leading from elements d, e, and n within vector register V1 to elements F, G, and H within memory area MA1, PackStore instruction 50 may cause processor 22 to pack non-contiguous elements d, e, and n from vector register V1 into contiguous memory locations (e.g., locations F, G, and H), starting at the specified memory location.

FIG. 4 is a block diagram depicting example arguments and storage constructs for executing a LoadUnpack instruction. In particular, FIG. 4 shows an example template 60 for a LoadUnpack instruction. For instance, LoadUnpack template 60 indicates that the LoadUnpack instruction may include an operation code (opcode) 62, and a number of arguments or parameters, such as a destination parameter 64, a source parameter 66, and a mask parameter 68. In the example of FIG. 4, opcode 62 identifies the instruction as a LoadUnpack instruction, destination parameter 64 specifies a source vector register to be used as a destination for the result, source parameter 66 specifies a source memory location, and mask parameter 68 specifies a mask register with bits that correspond to elements in the specified vector register.

In particular, FIG. 4 illustrates that the specific LoadUnpack instruction in template 60 associates mask register M1 with vector register V1. In addition, the upper-right table in FIG. 4 shows how different sets of bits in vector register V1 correspond to different vector elements. Furthermore, mask register M1 is shown aligned with vector register V1 to illustrate that bits in mask register M1 correspond to elements in vector register V1. Also, the lower-right table in FIG. 4 shows the different addresses associated with different locations within memory area MA1.

As indicated above, processor 22 may receive a processor instruction having a source parameter to specify a memory location, a mask parameter to specify a mask register, and destination parameter to specify a vector register. In response to receiving the processor instruction, processor 22 may copy data items from contiguous memory locations, starting at the specified memory location, into elements of the specified vector register which correspond to unmasked bits in the specified mask register, without copying data into vector elements which correspond to masked bits in the specified mask register.

Thus, as illustrated by the arrows leading from locations F, G, and H within memory area MA1 to elements d, e, and n within vector register V1, respectively, LoadUnpack instruction 60 may cause processor 22 to copy data from contiguous memory locations (e.g., locations F, G, and H), starting at the specified memory location (e.g., location F, at linear address 0b0101) into non-contiguous elements of vector register V1.

Thus, as has been described, the PackStore type of instruction allows select elements to be moved or copied from a source vector into contiguous memory locations, and the LoadUnpack type of instruction allows contiguous data items in memory to be moved or copied into select elements within a vector register. In both cases, the mappings are based at least in part on a mask register containing mask values that correspond to the elements of the vector register. These kinds of operations can often be “free” or have minimal performance impact, in the sense that the programmer may be able to replace loads and stores in their code with LoadUnpacks and PackStores with minimal, if any, additional setup instructions.

In light of the principles and example embodiments described and illustrated herein, it will be recognized that the illustrated embodiments can be modified in arrangement and detail without departing from such principles. For instance, in the embodiments of FIGS. 3 and 4, memory locations are referenced by linear address (e.g., by address bits defining a location within a 64-byte cache line). However, in other embodiments, other techniques may be used to identify memory locations.

Also, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, processes that use the same operations in a different sequence, and processes in which the individual operations disclosed herein are combined, subdivided, or otherwise altered.

Alternative embodiments of the invention also include machine accessible media encoding instructions for performing the operations of the invention. Such embodiments may also be referred to as program products. Such machine accessible media may include, without limitation, storage media such as floppy disks, hard disks, CD-ROMs, ROM, and RAM; and other detectable arrangements of particles manufactured or formed by a machine or device. Instructions may also be used in a distributed environment, and may be stored locally and/or remotely for access by single or multi-processor machines.

It should also be understood that the hardware and software components depicted herein represent functional elements that are reasonably self-contained so that each can be designed, constructed, or updated substantially independently of the others. The control logic for providing the functionality described and illustrated herein may be implemented as hardware, software, or combinations of hardware and software in different embodiments. For instance, the execution logic in a processor may include circuits and/or microcode for performing the operations necessary to fetch, decode, and execute machine instructions.

As used herein, the terms “processing system” and “data processing system” are intended to broadly encompass a single machine, or a system of communicatively coupled machines or devices operating together. Example processing systems include, without limitation, distributed computing systems, supercomputers, high-performance computing systems, computing clusters, mainframe computers, mini-computers, client-server systems, personal computers, workstations, servers, portable computers, laptop computers, tablets, telephones, personal digital assistants (PDAs), handheld devices, entertainment devices such as audio and/or video devices, and other platforms or devices for processing or transmitting information.

In view of the wide variety of useful permutations that may be readily derived from the example embodiments described herein, this detailed description is intended to be illustrative only, and should not be taken as limiting the scope of the invention. What is claimed as the invention, therefore, is all implementations that come within the scope and spirit of the following claims and all equivalents to such implementations.

What is claimed is:

1. A processor comprising:
execution logic to execute a processor instruction by performing operations comprising:
copying unmasked vector elements from a source vector register to consecutive memory locations, starting at a specified memory location, without copying masked vector elements from the source vector register.

2. A processor according to claim 1, wherein:
the unmasked vector elements comprise vector elements corresponding to bits having a first value in a mask register of the processor; and
the masked vector elements comprise vector elements corresponding to bits having a second value in the mask register.

3. A processor according to claim 1, further comprising:
a vector register to hold a number of vector elements, the vector register operable to serve as the source vector register; and
a mask register to hold a number of mask bits at least equal to the number of vector elements.

4. A processor according to claim 1, wherein:
the specified memory location comprises a memory location specified by an argument of the processor instruction.

5. A processor according to claim 1, wherein:
the processor instruction comprises a first instruction, and
the execution logic is operable, in response to a second processor instruction with an argument identifying a memory location, to copy data items from consecutive memory locations, starting at the identified memory location, into unmasked vector elements of a destination vector register, without modifying masked vector elements of the destination vector register.

6. A processor according to claim 5, wherein:
the processor comprises multiple vector registers and multiple mask registers; and
the first and second processor instructions each comprise arguments to identify a desired vector register among the multiple vector registers, to identify a corresponding mask register among the multiple mask registers, and to identify a desired memory location.

7. A processor according to claim 5, wherein the first processor instruction comprises a PackStore instruction, and the second processor instruction comprises a LoadUnpack instruction.

8. A processor according to claim 1, wherein:
the processor comprises multiple vector registers; and
the processor instruction comprises a source argument to identify a desired vector register among the multiple vector registers.

9. A processor according to claim 1, wherein:
the processor comprises multiple mask registers; and
the processor instruction comprises a mask argument to identify a desired mask register among the multiple mask registers.

10. A processor according to claim 1, wherein:
the processor comprises multiple vector registers and multiple mask registers; and
the processor instruction comprises a source argument to identify a desired vector register among the multiple vector registers, and a mask argument to identify a corresponding mask register among the multiple mask registers.

11. A processor according to claim 1, further comprising:
multiple processing cores, at least two of which comprise circuits operable to execute PackStore instructions and LoadUnpack instructions.

12. A processor according to claim 1, wherein the processor instruction comprises a conversion indicator, the circuit further operable to perform a format conversion on a vector element, based at least in part on the conversion indicator, before storing that vector element in memory.

13. A machine-accessible medium having a PackStore instruction stored therein, wherein:
the PackStore instruction comprises an argument to identify a memory location; and
the PackStore instruction, when executed by a processor, causes the processor to copy unmasked vector elements from a source vector register to consecutive memory locations, starting at the identified memory location, without copying masked vector elements.

14. A machine-accessible medium according to claim 13, wherein the PackStore instruction further comprises:
a source argument to identify the source vector register; and
a mask argument to identify a corresponding mask register.

15. A machine-accessible medium according to claim 13, wherein the PackStore instructions further comprises:
a conversion indicator to specify a format conversion to be performed on a vector element before the processor stores that vector element in memory.

16. A machine-accessible medium having a LoadUnpack instruction stored therein, wherein:
the LoadUnpack instruction comprises an argument to identify a memory location; and
the LoadUnpack instruction, when executed by a processor, causes the processor to copy data items from consecutive memory locations, starting at the identified memory location, into unmasked vector elements of a target vector register, without modifying masked vector elements of the target vector register.

17. A machine-accessible medium according to claim 16 wherein the LoadUnpack instruction further comprises:
a target argument to identify the target vector register; and
a mask argument to identify a corresponding mask register.

18. A machine-accessible medium according to claim 16, wherein the LoadUnpack instructions further comprises:
a conversion indicator to specify a format conversion to be performed on a data item before the processor stores that data item in the target vector register.

19. A method for handling vector instructions, the method comprising:
receiving a processor instruction having a source parameter to specify a vector register, a mask parameter to specify a mask register, and destination parameter to specify a memory location; and
in response to receiving the processor instruction, copying unmasked vector elements from the specified vector register to consecutive memory locations, starting at the specified memory location, without copying masked vector elements.

20. A method according to claim 19, wherein:
each vector element occupies a predetermined number of bits in the vector register;
the processor instruction comprises a conversion indicator;
in response to receiving the processor instruction, a vector element is automatically converted according to the conversion indicator before that vector element is stored in memory; and
the vector element is stored as a data item that occupies a different number of bits than said predetermined number of bits.

21. A method according to claim 19, wherein:
the unmasked vector elements comprises vector element that correspond to unmasked bits in the specified mask register; and
the masked vector elements comprises vector element that correspond to masked bits in the specified mask register.

22. A method for handling vector instructions, the method comprising:
receiving a processor instruction having a source parameter to specify a memory location, a mask parameter to specify a mask register, and a destination parameter to specify a vector register; and
in response to receiving the processor instruction, copying data from consecutive memory locations, starting at the specified memory location, into unmasked vector elements of the specified vector register, without copying data into masked vector elements of the specified vector register.

23. A method according to claim 22, wherein:
each data item occupies a predetermined number of bits in memory;
the processor instruction comprises a conversion indicator;
in response to receiving the processor instruction, a data item is automatically converted according to the conversion indicator before that data items is stored in the destination vector register; and
the data item is stored as a vector element that occupies a different number of bits than said predetermined number of bits.

24. A method according to claim 22, wherein:
the unmasked vector elements comprises vector element that correspond to unmasked bits in the specified mask register; and
the masked vector elements comprises vector element that correspond to masked bits in the specified mask register.

25. A computer system, comprising:
memory to store a PackStore instruction; and
a processor, coupled to the memory, the processor comprising control logic to decode the PackStore instruction.

26. A computer system according to claim 25, wherein:
the processor comprises multiple vector registers and multiple mask registers; and
the PackStore instruction comprises a source argument to identify a desired vector register among the multiple vector registers, and a mask argument to identify a corresponding mask register among the multiple mask registers.

27. A computer system according to claim 25, wherein the processor comprises multiple processing cores, at least two of which comprise circuits operable to execute PackStore instructions.

28. A computer system, comprising:
memory to store a LoadUnpack instruction; and
a processor, coupled to the memory, the processor comprising control logic to decode the LoadUnpack instruction.

29. A computer system according to claim 28, wherein:
the processor comprises multiple vector registers and multiple mask registers; and
the LoadUnpack instruction comprises a target argument to identify a desired vector register among the multiple vector registers, and a mask argument to identify a corresponding mask register among the multiple mask registers.

30. A computer system according to claim 25, wherein the processor comprises multiple processing cores, at least two of which comprise circuits operable to execute LoadUnpack instructions.
